(19) United States
(12) Patent Application Publication
(10) Pub. No.: US 2025/0392471 A1
(43) Pub. Date: Dec. 25, 2025

(54) SYSTEMS AND METHODS FOR SECURE PROVENANCE OF TRANSACTION DATA WITH DIGITAL SIGNATURE

(71) Applicant: Stripe, Inc., South San Francisco, CA (US)

(72) Inventor: Graham Andrew West, London (GB)

(21) Appl. No.: 18/747,680

(22) Filed: Jun. 19, 2024

(51) Int. Cl. H04L 9/32; H04L 9/14

(52) U.S. Cl. CPC H04L 9/3247; H04L 9/14

(57) ABSTRACT

A method and system for a secured data transaction are disclosed. The method can include receiving, by a server system, transaction data and a data descriptor. The data descriptor includes information about the transaction data and a digital signature of the data descriptor. The method can further include looking up, by the server system, a public key based on the data descriptor. The method can further include determining, by the server system, whether the digital signature of the data descriptor was signed by a private key corresponding to the public key. The method can further include in response to determining that the digital signature of the data descriptor was signed by the private key corresponding to the public key, allowing, by the server system, the receipt of the transaction data.

### BACKGROUND

Service provider systems provide various services to user systems over computing networks. The services provided can include commercial transaction processing services, media access services, customer relationship management services, data management services, medical services, etc., as well as a combination of such services. Modern computing techniques employed by many service provider systems typically involve deploying the functions of the service provider systems as distributed services. That is, each service may be responsible for a discrete set of functions, and the services and associated functions operate autonomously or in conjunction with one another as a whole to provide the overall functionality of a service provider system. By dividing the overall functionality of service provider systems in this way, the services may be distributed to different computing systems, multiple instances of the same services used concurrently, etc. to adapt to system load, network connectivity issues, instances of services going down, as well as other technical challenges with implementing distributed service provider systems.

In each of the above service provider systems, users of a service provider system typically interact with the service provider system via messaging over a computing network. For example, a user may make transmit an electronic request message for one of many types of services supported by the service provider system. Then, the one or more of the services of the distributed service provider system will perform functions of the service provider system to implement the originally requested service requested by the user. For example, the service request message may be a media access service request, a telecommunications service request, a financial processing service request, etc., and one or more services of the service provider system are invoked to process the user's request.

During each of the operations performed by the service provider system to process the user's service request, the services of the service provider system may generate and store, or seek to access stored, data associated with the service, the user, or other data. The data may include data associated with fraud detection services, bookkeeping services, record keeping services, regulatory services, end user data, service system data, third party system data, as well as other data that may be generated or accessed during the overall processing of the service system request. The service provider systems may receive and process millions, billions, or more service system requests per hour, day, week, etc., resulting in an enormous scale of data generation and access operations of the services of the service provider system.

To ensure the source of the data described above is from an intended source, a service provider system may provide the user with a unique identifier (e.g., a virtual account number) which can be used by the user to receive transaction data (e.g., top up or payout) from another user through the service provider system or another service provider system. The service provider system may have restrictions on the source that sends the transaction data to the account with the unique identifier and it is in the interest of the service provider system to block unauthorized or unauthentic transaction data.

Unfortunately, a fraudulent user with a provided identifier (e.g., another virtual account number) can still attempt to defraud potential victims through the service provider system by requesting the victims to send transaction data (e.g., payments for counterfeit or undelivered goods) to their fraudulent account with the provided identifier. Once the victims send the transaction data to that fraudulent account, the existing fraudulent detection service of the service provider system does not necessarily detect the source of the transaction data as unauthorized or unauthentic (e.g., non-merchant), or potentially fraudulent, and allows the transaction data to be deposited in the fraudulent account. The fraudulent user, therefore, can exfiltrate the deposited transaction data before a victim can attempt recovery.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 is a block diagram of a system architecture for a platform system according to an embodiment.

FIG. 2 is a block diagram of a service provider system communicating with a platform system according to an embodiment.

FIG. 3 is a flow diagram of a process for a secured data transaction according to an embodiment.

FIG. 4 is a flow diagram of another process for a secured data transaction according to an embodiment.

FIG. 5 is an embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “sending”, “looking up”, “determining”, “allowing”, “blocking”, “assigning”, “generating”, “signing”, “adding”, “encoding”, “decoding”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Embodiments of the disclosure may use a cryptographic digital signature to sign transaction information and include a statement descriptor with the sent transaction data.

In one aspect, a method for a secured data transaction is provided. The method can include receiving, by a server system, transaction data and a data descriptor. The data descriptor includes information about the transaction data and a digital signature of the data descriptor. The method can further include looking up, by the server system, a public key based on the data descriptor. The method can further include determining, by the server system, whether the digital signature of the data descriptor was signed by a private key corresponding to the public key. The method can further include in response to determining that the digital signature of the data descriptor was signed by the private key corresponding to the public key, allowing, by the server system, the receipt of the transaction data.

In another aspect, a method for a secured data transaction is provided. The method can include generating, by a service provider system, a public-private key pair having a public key and a private key corresponding to the public key. The method can further include sending, by the service provider system to a server system, the public key and a request to register the public key. The method can further include receiving, by the service provider system from the server system, a sender identifier corresponding to the public key.

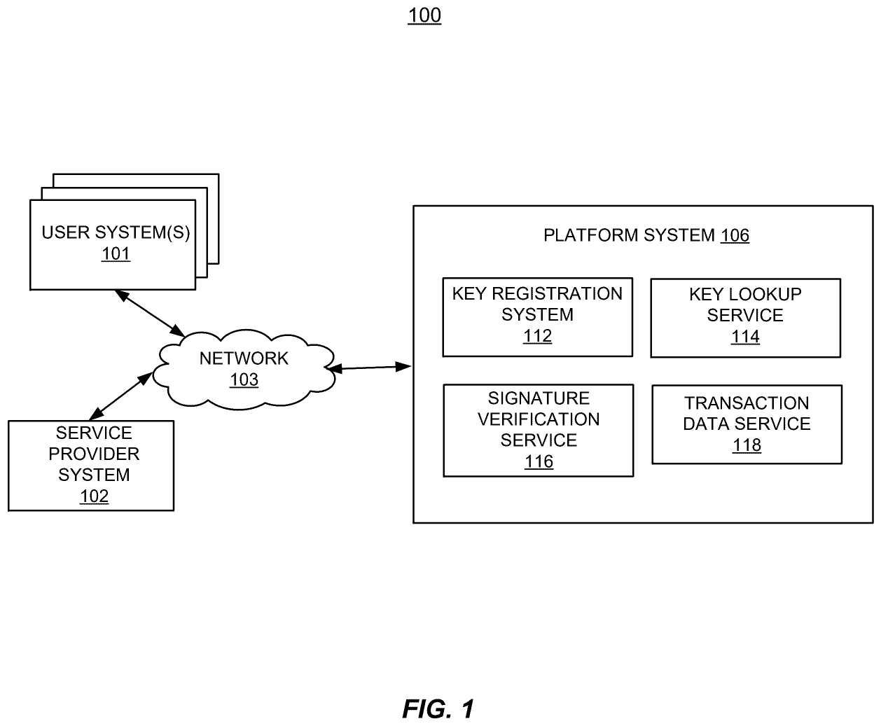

FIG. 1 is a block diagram of a system architecture for a platform system according to an embodiment. Referring to FIG. 1, in an embodiment, system architecture 100 includes, but not limited to, one or more end user systems 101, a service provider system 102 and a platform system 106. In an embodiment, the end user system(s) 101 may be mobile computing devices, such as a smartphone, tablet computer, smartwatch, etc., as well computer systems, such as a desktop computer system, laptop computer system, server computer systems, etc. The service provider system 102, end user system(s) 101, and platform system 106 may also be one or more computing devices, such as one or more server computer systems (e.g., cloud server systems), desktop computer systems, etc.

With continued reference to FIG. 1, the service provider system 102, end user system(s) 101, and platform system 106 may be coupled to a network 103 and communicate with one another using any of the standard protocols for the exchange of information, including secure communication protocols. In an embodiment, one or more of the service provider system 102 and end user system(s) 101 may run on a local area network (LAN) and may be incorporated into the same physical or logical system, or different physical or logical systems. Alternatively, the service provider system 102 and end user system(s) 101 may reside on different LANs, wide area networks (WANs), cellular telephone networks, etc. that may be coupled together via the Internet but separated by firewalls, routers, and/or other network devices. In an embodiment, service provider system 102 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In an embodiment, service provider system 102 may provide financial processing services to one or more merchants, such as end user system(s) 101. For example, service provider system 102 may manage merchant accounts held at the commerce platform, run financial transactions initiated at end user system(s) 101, clear transactions, performing payouts to merchant and/or merchant agents, manage merchant and/or agent accounts held at the service provider system 102, as well as other services typically associated with commerce platforms systems. Each of these functions may be carried out by one or more service system(s) of the service provider system 102. That is, service provider system 102 may divide the services it provides to end users among one or more service system(s), so that the processing of the services may be distributed. Such distribution of service processing enables service provider systems to scale based on load, demand, hardware issues, geographic needs, expanded service offerings, as well as for other reasons.

Service provider system 102 may provide numerous services to end user systems(s) 101. For example, where service provider system 102 is a commerce platform, the services may include running financial transactions for merchant end users, managing agent accounts of merchants, performing tax accounting services as a result of the various financial transactions, performing data control and management of merchant data, providing platform hosting services, and any other such services. Each of these services may be initiated at the request of an end user system 101, by another service system, or a combination thereof.

In an embodiment, platform system 106 may serve as a secure data transaction system to ensure transfers of transaction data are authentic (e.g., non-fraudulent). Platform system 106 may be an independent third-party system or may be implemented as part of service provider system 102. As shown in FIG. 1, platform system 106 may include, but not limited to, a key registration system 112, a key lookup service 114, a signature verification service 116, and a transaction data service 118.

Key registration system 112 may enable a service provider system (e.g., service provider system 102) to register a public key with registration system 112. For example, the service provider system may generate a public-private key pair, and send the public key from the key pair to key registration system 112 with a request to register the public key. In response to receiving the public key and the request, registration system 112 may store the public key, generate a unique sender (or service provider) identifier corresponding to the public key, and send the sender identifier to the service provider system.

In an embodiment, key lookup service 114 may perform a lookup of a public key (e.g., a public key previously stored by registration system 112) based on a data descriptor received by transaction data service 118. The data descriptor, for example, may include information about certain transaction data received by transaction data service 118, and a cryptographic digital signature. The information about the transaction data may include a transaction identifier, a transaction date, a transaction amount, and/or a sender identifier previously registered with registration system 112. Therefore, key lookup service 114 may look up the public key (e.g., from a data store) using the corresponding sender identifier in the data descriptor.

In an embodiment, signature verification service 116 may determine whether or not a digital signature from the data descriptor was signed by a private key that corresponds to (or matches) a looked up public key. As previously described, the private key and public key may form a public-private key pair previously generated by the service system provider. If it is determined that the digital signature of the data descriptor was signed by the private key corresponding to the looked up public key, verification service 116 may determine that the receipt of the transaction data is authentic (e.g., non-fraudulent) and allow the transaction data to be received and stored by platform system 106. Otherwise, verification service 116 may block the transaction data and determine that the receipt of the transaction data is unauthentic (e.g., fraudulent).

Transaction data service 118 may communicate with service provider system 102 over network 103 to receive transaction data and a corresponding data descriptor from service provider system 102. In an embodiment, transaction data service 118 may extract the data descriptor from a payload carrying the transaction data and data descriptor, and forward the data descriptor to the key lookup service 114 and verification service 116 to perform their respective operations, as previously described.

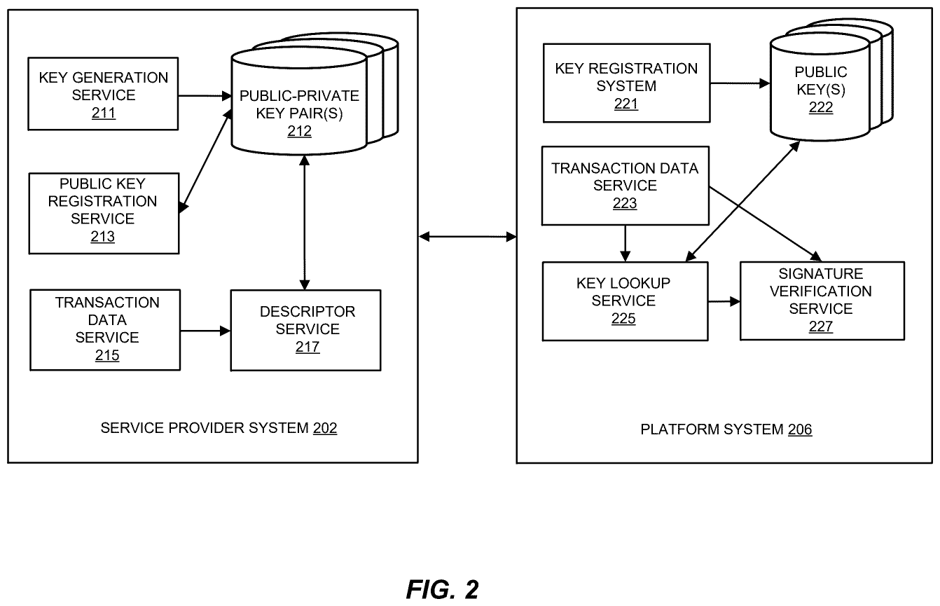

FIG. 2 is a block diagram of a service provider system communicating with a platform system according to an embodiment. Referring to FIG. 2, service provider system 202 may communicate with platform system 206 over a network (e.g., network 103 of FIG. 1). Platform system 206 may be an independent third-party system or may be implemented as part of service provider system 202. Service provider system 102 and platform system 206 may be one or more computing devices, such as one or more server computer systems (e.g., cloud server systems), desktop computer systems, etc.

As shown, service provider system 202 may include, but not limited to, key generation service 211, public-private key pair(s) data store or database 212 (e.g., AWS Aurora PostgreSQL, MongoDB, etc.), public key registration service 213, transaction data service 215, and descriptor service 217. Platform system 206 may include, but not limited to, key registration system 221, public key(s) data store or database 222 (e.g., AWS Aurora PostgreSQL, MongoDB, etc.), transaction data service 223, key lookup service 225, and signature verification service 227.

In an embodiment, key generation service 211 may generate a public-private key pair for service provider system 202 (e.g., a user account of the service provider system 202) using a key generator, and store the public-private key pair in public-private key pair(s) data store 212. The public-private key pair may be generated using any cryptographic algorithm, such as advanced encryption standard (AES), RSA (Rivest, Shamier and Adleman), elliptic curve cryptography (ECC), hash function, etc.

Public key registration service 213 serves to register the public key from a generated public-private key pair with key registration system 221 of platform system 206. For example, registration service 213 may query the public-private key pair(s) data store 212 to obtain or fetch a public-private key pair for registration. Registration service 213 may then send the public key of the key pair and a request to register that public key to the key registration system 221. The key registration system 221 may then receive the public key and request, and in response to the request, key registration system 221 may generate a sender (or service provider) identifier, assign the sender identifier to the received public key, store the public key and corresponding assigned sender identifier in public key(s) data store 222, and send the sender identifier back to the service provider system 202 to complete the key registration.

Transaction data service 215 may be enabled to prepare transaction data (e.g., top up or payout), initiated at end user system(s) 101, to be sent directly to platform system 206, or indirectly to platform system 206 through another service provider system that, for example, manages merchant accounts, performs payouts to merchant and/or merchant agents, manages merchant and/or agent accounts held at the service provider system and also other services typically associated with commerce platforms systems.

Descriptor service 217 may generate a data descriptor, which may be a unique value, having information that describes the transaction data. For example, the information may include a transaction identifier, a transaction date, a transaction amount, and/or a sender identifier previously received from and registered with registration system 221. The data descriptor may also include a digital signature that serves to validate the authenticity and integrity of the transaction data to prevent or protect a recipient (e.g., merchant account held at service provider system 202) from receiving unauthentic transaction data. In an embodiment, descriptor service 217 may sign the information (or a portion of the information, such as the transaction identifier, transaction date and transaction amount) using the private key from the generated public-private key pair to produce the digital signature. Descriptor service 217 may then add the digital signature to the descriptor. In an embodiment, the data descriptor may be encoded in a terse format to fit within a specific descriptor length (e.g., 22 characters). In some embodiments, the data descriptor may also include metadata such as a merchant (or user) identifier and/or transaction data type (e.g., acquiring). Thus, the metadata may also be signed as part of the digital signature. Descriptor service 217 may then send the transaction data and data descriptor to platform system 206. As previously described, the data descriptor may include information that describes the transaction data being sent with the descriptor. For example, the information may include a transaction identifier, a transaction date, a transaction amount, and/or a sender identifier (which may be previously received from and registered with registration system 221). Some or all of the information may be signed using the private key from the generated public-private key pair to produce a digital signature, which may also be included in the data descriptor. In some embodiments, the transaction data and its data descriptor may be sent in a single payload or multiple payloads.

With reference to platform system 206, transaction data service 223 may receive the transaction data and its data descriptor. Data service 223 may extract the data descriptor from one or more payloads and send the data descriptor to key lookup service 225 and signature verification service 227.

Based on the sender identifier from the data descriptor, key lookup service 225 may look up a public key in public key(s) data store 222. For example, using the sender identifier, service 225 may query public key(s) data store 222 to obtain or fetch a public key corresponding to that sender identifier. Service 225 may then send the obtained public key to verification service 227 for verification.

In an embodiment, signature verification service 227 may verify the digital signature of the data descriptor to determine whether the digital signature was signed by a private key that pairs with the looked up public key. The private key and public key may form a public-private key pair previously generated by key generation service 211. If it is determined that the digital signature of the data descriptor was signed by the private key that pairs with the looked up public key, verification service 227 may determine that the transaction data is authentic (e.g., non-fraudulent) and allow the transaction data to be received and stored by platform system 206. Otherwise, if it is determined that the digital signature was signed by a private key that does not pair with the looked up public key, verification service 227 may determine that the transaction data is unauthentic (e.g., fraudulent or potentially fraudulent) and block the receipt of the transaction data.

In an embodiment, transaction data service 223 may receive another transaction data with another data descriptor and send this other data descriptor to verification service 227. This other transaction data and its associated data descriptor may be duplicate transaction data and data descriptor sent by service provider system 202, initiated at end user system(s) 101. The transaction data, for example, may include top up or payout that was previously received by transaction data service 223 (i.e., duplicate top up or payout), though the embodiments of the disclosure are not limited to this configuration. Verification service 227 may determine whether the other data descriptor is same as the data descriptor previously received. If so, service 227 may block the receipt of the other transaction data, thereby blocking duplicate transaction data with the same descriptor to prevent replay attacks. In some embodiments, verification service 227 may also enforce verification of a date range based on the transaction date in the data descriptor.

As previously described, in some embodiments, the data descriptor may be encoded in a terse format to fit within a specific descriptor length. In this scenario, verification service 227 may need to decode the data descriptor using terse coding prior to verifying the digital signature.

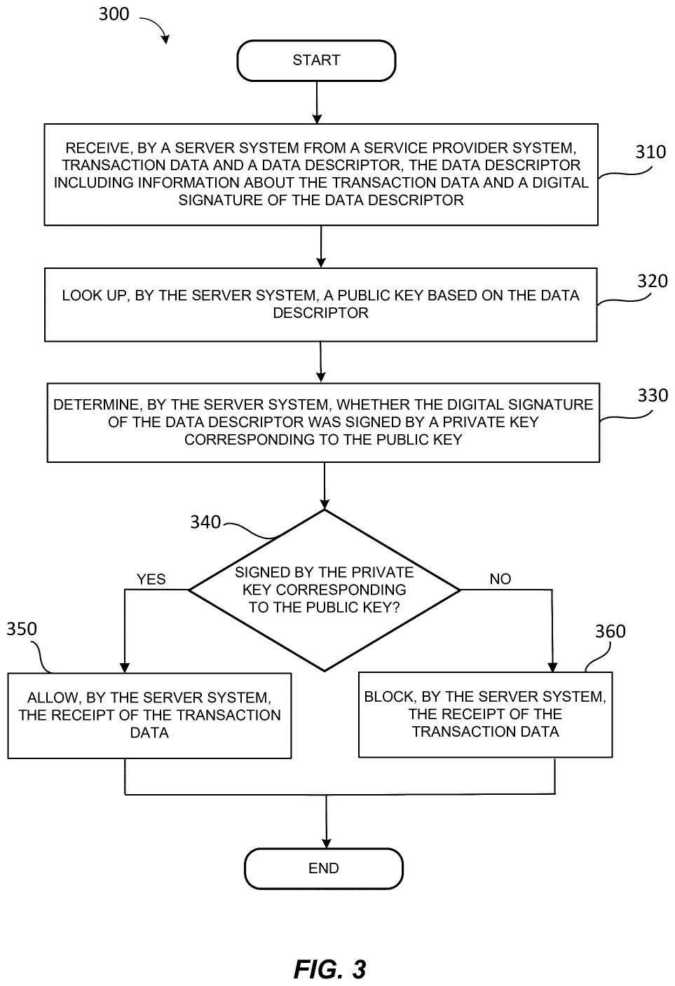

FIG. 3 is a flow diagram of a process for a secured data transaction according to an embodiment. Method 300 may be performed by processing logic that may comprise hardware (circuitry, dedicated logic, etc.), software (such as is run on a general purpose computer system or a dedicated machine), firmware, or a combination. In one embodiment, the method 300 is performed by platform system 206 of FIG. 2 (e.g., key registration system 221, transaction data service 223, key lookup service 225, and signature verification service 227).

Referring to FIG. 3, at block 310, the processing logic may receive, by a server system (e.g., server hosting platform system 206) from a service provider system (e.g., service provider system 202), transaction data (e.g., top up, payout, etc.) and a data descriptor. The data descriptor may include information about the transaction data and a digital signature of the data descriptor. At block 320, the processing logic may look up, by the server system, a public key based on the data descriptor (e.g., based on a sender identifier from the data descriptor). At block 330, the processing logic may determine, by the server system, whether the digital signature of the data descriptor was signed by a private key that corresponds to (or pairs with) the looked up public key. At block 340, if it is determined that the digital signature was signed by the private key corresponding to the looked up public key, the processing logic proceeds to block 350. Otherwise, if it is determined that the digital signature was not signed by the private key corresponding to the looked up public key, the processing logic proceeds to block 360. At block 350, the processing logic may allow, by the server system, the receipt of the transaction data. For example, the processing logic may determine that the transaction data is authentic and enable the transaction data to be stored or deposited. At block 360, the processing logic may block, by the server system, the receipt of the transaction data. For example, the processing logic may determine that the transaction data is unauthentic and block the transaction data from being stored or deposited.

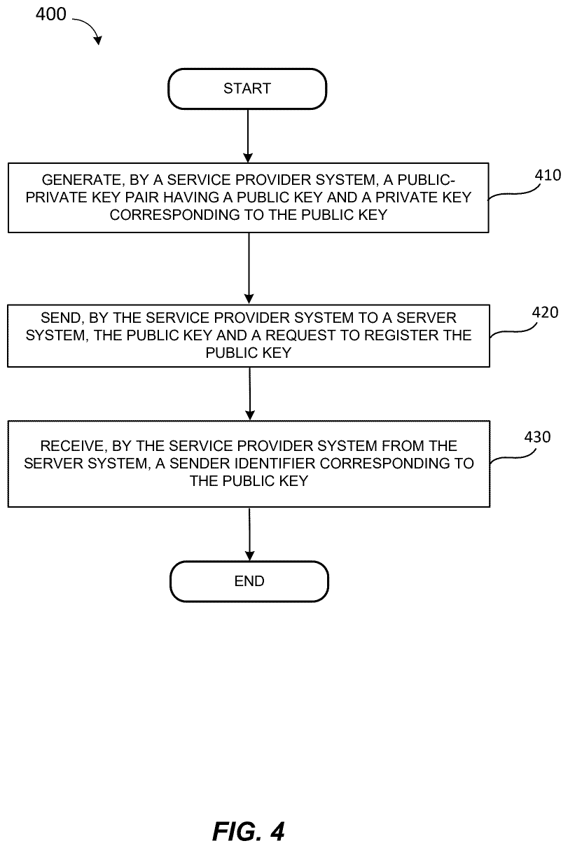

FIG. 4 is a flow diagram of another process for a secured data transaction according to an embodiment. Method 400 may be performed by processing logic that may comprise hardware (circuitry, dedicated logic, etc.), software (such as is run on a general purpose computer system or a dedicated machine), firmware, or a combination. In one embodiment, the method 400 is performed by service provider system 202 of FIG. 2 (e.g., key registration service 213).

Referring to FIG. 4, at block 410, the processing logic may generate a public-private key pair having a public key and a private key corresponding to the public key. At block 420, the processing logic may send to a server system (e.g., server system hosting platform system 206 of FIG. 2) the public key and a request to register the public key. At block 430, the processing logic may receive from the server system a sender (or service provider) identifier corresponding to the public key.

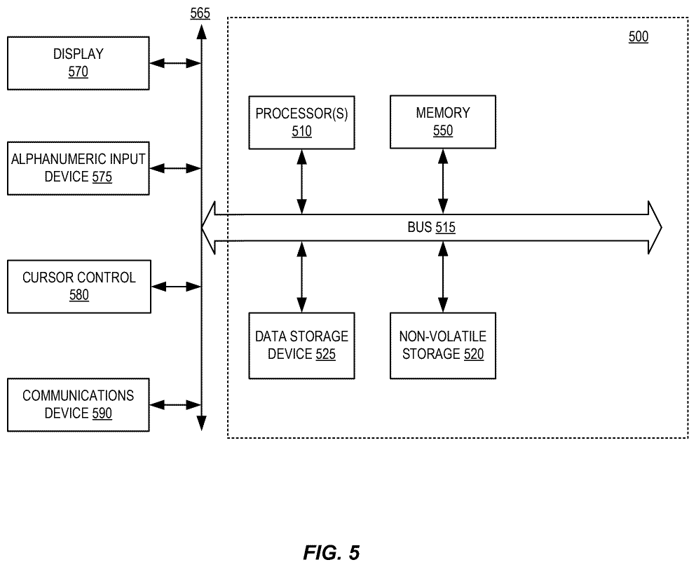

FIG. 5 is an embodiment of a computer system that may be used to support the systems and operations discussed herein. The data processing system illustrated in FIG. 5 includes a bus or other internal communication means 515 for communicating information, and one or more processors 510 coupled to the bus 515 for processing information. The system further comprises a random access memory (RAM) or other volatile storage device 550 (referred to as memory), coupled to bus 515 for storing information and instructions to be executed by processor(s) 510. Main memory 550 also may be used for storing temporary variables or other intermediate information during execution of instructions by processor(s) 510. The system also comprises a read only memory (ROM) and/or static storage device 520 coupled to bus 515 for storing static information and instructions for processor(s) 510, and a data storage device 525 such as a magnetic disk or optical disk and its corresponding disk drive. Data storage device 525 is coupled to bus 515 for storing information and instructions.

The system may further be coupled to a display device 570, such as a light emitting diode (LED) display or a liquid crystal display (LCD) coupled to bus 515 through bus 565 for displaying information to a computer user. An alphanumeric input device 575, including alphanumeric and other keys, may also be coupled to bus 515 through bus 565 for communicating information and command selections to processor(s) 510. An additional user input device is cursor control device 580, such as a touchpad, mouse, a trackball, stylus, or cursor direction keys coupled to bus 515 through bus 565 for communicating direction information and command selections to processor(s) 510, and for controlling cursor movement on display device 570.

Another device, which may optionally be coupled to computer system 500, is a communication device 590 for accessing other nodes of a distributed system via a network. The communication device 590 may include any of a number of commercially available networking peripheral devices such as those used for coupling to an Ethernet, token ring, Internet, or wide area network. The communication device 590 may further be a null-modem connection, or any other mechanism that provides connectivity between the computer system 500 and the outside world. Note that any or all of the components of this system illustrated in FIG. 5 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 550, mass storage device 525, or other storage medium locally or remotely accessible to processor 510.

It will be apparent to those of ordinary skill in the art that the system, method, and process described herein can be implemented as software stored in main memory 550 or read-only memory 520 and executed by processor(s) 510. This control logic or software may also be resident on an article of manufacture comprising a computer readable medium having computer readable program code embodied therein and being readable by the mass storage device 525 and for causing the processor(s) 510 to operate in accordance with the methods and teachings herein.

The embodiments discussed herein may also be embodied in a handheld or portable device containing a subset of the computer hardware components described above. For example, the handheld device may be configured to contain only the bus 515, the processor(s) 510, and memory 550 and/or 525. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include processor(s) 510, a data storage device 525, a bus 515, and memory 550, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A computer-implemented method for a secured data transaction, the method comprising:
receiving, by a server system, transaction data and a data descriptor, the data descriptor including information about the transaction data and a digital signature of the data descriptor;
looking up, by the server system, a public key based on the data descriptor;
determining, by the server system, whether the digital signature of the data descriptor was signed by a private key corresponding to the public key; and
in response to determining that the digital signature of the data descriptor was signed by the private key corresponding to the public key, allowing, by the server system, the receipt of the transaction data.

2. The method of claim 1, further comprising:
in response to determining that the digital signature of the data descriptor was not signed by the private key corresponding to the public key, blocking, by the server system, the receipt of the transaction data.

3. The method of claim 1, further comprising:
receiving, by the server system, another transaction data and another data descriptor, the another data descriptor including information about the another transaction data and a digital signature of the another data descriptor;
determining, by the server system, whether the another data descriptor is same as the data descriptor; and
in response to determining that the another data descriptor is same as the data descriptor, blocking, by the server system, the receipt of the another transaction data.

4. The method of claim 1, wherein:
the data descriptor is encoded in a terse format to fit within a specific descriptor length;
the method further comprises: decoding the data descriptor using terse coding.

5. The method of claim 4, wherein:
the decoded data descriptor comprises a sender identifier; and
looking up the public key comprises: looking up, by the server system, a public key corresponding to the sender identifier.

6. The method of claim 1, further comprising:
receiving, by the server system, the public key;
assigning, by the server system, a sender identifier corresponding to the public key; and
sending, by the server system, the sender identifier.

7. The method of claim 1, wherein the data descriptor includes a sender identifier and at least one of: a transaction identifier, a date, or an amount.

8. The method of claim 1, wherein the public key and the private key corresponding to the public key form a public-private key pair.

9. One or more non-transitory computer readable storage media having instructions stored thereupon which, when executed by a system having at least a processor and a memory therein, cause the system to perform operations, the operations comprising:
receiving, by a server system, transaction data and a data descriptor, the data descriptor including information about the transaction data and a digital signature of the data descriptor;
looking up, by the server system, a public key based on the data descriptor;
determining, by the server system, whether the digital signature of the data descriptor was signed by a private key corresponding to the public key; and
in response to determining that the digital signature of the data descriptor was signed by the private key corresponding to the public key, allowing, by the server system, the receipt of the transaction data.

10. The one or more non-transitory computer readable storage media of claim 9, wherein the operations further comprise:
in response to determining that the digital signature of the data descriptor was not signed by the private key corresponding to the public key, blocking, by the server system, the receipt of the transaction data.

11. The one or more non-transitory computer readable storage media of claim 9, wherein the operations further comprise:
receiving, by the server system, another transaction data and another data descriptor, the another data descriptor including information about the another transaction data and a digital signature of the another data descriptor;
determining, by the server system, whether the another data descriptor is same as the data descriptor; and
in response to determining that the another data descriptor is same as the data descriptor, blocking, by the server system, the receipt of the another transaction data.

12. The one or more non-transitory computer readable storage media of claim 9, wherein:
the data descriptor is encoded in a terse format to fit within a specific descriptor length;
the operations further comprise: decoding the data descriptor using terse coding.

13. The one or more non-transitory computer readable storage media of claim 12, wherein:
the decoded data descriptor comprises a sender identifier; and
looking up the public key comprises: looking up, by the server system, a public key corresponding to the sender identifier.

14. The one or more non-transitory computer readable storage media of claim 9, wherein the operations further comprise:
receiving, by the server system, the public key;
assigning, by the server system, a sender identifier corresponding to the public key; and
sending, by the server system, the sender identifier.

15. The one or more non-transitory computer readable storage media of claim 9, wherein the data descriptor includes a sender identifier and at least one of: a transaction identifier, a date, or an amount.

16. The one or more non-transitory computer readable storage media of claim 9, wherein the public key and the private key corresponding to the public key form a public-private key pair.

17. A computer-implemented method for a secured data transaction, the method comprising:
generating, by a service provider system, a public-private key pair having a public key and a private key corresponding to the public key;
sending, by the service provider system to a server system, the public key and a request to register the public key; and
receiving, by the service provider system from the server system, a sender identifier corresponding to the public key.

18. The method of claim 17, further comprising:
generating, by the service provider system, a data descriptor including information about transaction data to be sent by the service provider system;
signing, by the service provider system, the data descriptor using the private key, to produce a digital signature of the data descriptor;
adding, by the service provider system, the digital signature of the data descriptor to the data descriptor; and
sending, by the service provider system to the server system, the transaction data and the data descriptor, the data descriptor including the information about the transaction data and the digital signature of the data descriptor.

19. The method of claim 18, wherein the data descriptor includes the sender identifier and at least one of: a transaction identifier, a date, or an amount.

20. The method of claim 18, wherein:
prior to sending the transaction data and the data descriptor, the method further comprises encoding, by the service provider system, the data descriptor in a terse format to fit within a specific descriptor length;
sending the transaction data and the data descriptor comprises sending, by the service provider system to the server system, the transaction data and the encoded data descriptor.
